(19) United States
(12) Patent Application Publication
(10) Pub. No.: US 2023/0071583 A1
(43) Pub. Date: Mar. 9, 2023

(54) Method for Producing Spherical Nanocarbon Fiber Assembly, Method for Producing Carbon Nanorod and Method for Producing Graphene Nanoribbon

(71) Applicant: Nippon Telegraph and Telephone Corporation, Tokyo (JP)

(72) Inventors: Masaya Nohara, Musashino-shi, Tokyo (JP); Mikayo Iwata, Musashino-shi, Tokyo (JP); Yuzu Kobayashi, Musashino-shi, Tokyo (JP); Hiroaki Taguchi, Musashino-shi, Tokyo (JP); Takeshi Komatsu, Musashino-shi, Tokyo (JP)

(21) Appl. No.: 17/793,978

(22) PCT Filed: Jan. 20, 2020
(86) PCT No.: PCT/JP2020/001729

§ 371 Date: Jul. 20, 2022

(51) Int. Cl. C01B 32/19; C01B 32/18

(52) U.S. Cl. CPC C01B 32/19; C01B 32/18; C01P 2004/32; C01P 2004/17; B82Y 40/00

(57) ABSTRACT

A method for producing a spherical nanocarbon fiber assembly, including: freezing a dispersion liquid containing cellulose nanofibers by spraying the dispersion liquid on a brine solution to obtain a frozen product; drying the frozen product in a vacuum to obtain a dried product; and heating the dried product in an atmosphere that does not burn the dried product, thereby carbonizing the dried product to obtain a spherical nanocarbon fiber assembly.

### TECHNICAL FIELD

The present invention relates to a method for producing a spherical nanocarbon fiber assembly, a method for producing a carbon nanorod, and a method for producing a graphene nanoribbon.

### BACKGROUND ART

In recent years, nanocarbon materials with nanometer-sized microstructures such as graphene, fullerene, carbon nanofibers, carbon nanohorns, carbon nanorods, and graphene nanoribbons have been attracting attention as next-generation functional materials due to their unique shapes.

Carbon nanofibers are generally fibrous with an outer diameter of 5 to 100 nm and a fiber length of 10 or more times the outer diameter, and have high electrical conductivity and high specific surface area.

However, carbon nanofibers have strong cohesion and form bundle-like aggregates called bundles, which are difficult to disperse evenly and not easy to handle.

To improve the dispersibility of carbon nanofibers, spherical nanocarbon fiber assemblies prepared by radially growing a nanocarbon material with diamond as the core have been studied (NPL 1).

### CITATION LIST

### Non Patent Literature

NPL 1: K. Nakagawa, et. al., “A novel spherical carbon” Journal of Materials Science, 44, (2009) 221-226.
NPL 2: Y. Liu, et. al., “Carbon nanorods” Chemical Physics Letters, 331, (2000) 31-34.
NPL 3: A. Celis, et. al., “Graphene nanoribbons: fabrication, properties and devices” J. Phys. D: Appl. Phys., 49, (2016) 143001.

### SUMMARY OF THE INVENTION

### Technical Problem

As a method for producing spherical nanocarbon fiber assemblies, for example, an electrode discharge method, a vapor phase growth method, and a laser method are known (NPL 1). These production methods have the problems of difficulty in mass production and high cost. In addition, the production of spherical nanocarbon fiber assemblies by these methods requires catalyst-supported diamond as a core.

As a method for producing carbon nanorods and graphene nanoribbons, for example, an electrode discharge method, a vapor phase growth method, and a laser method are known (NPLs 2 and 3). These production methods also have problems such as difficulty in mass production and high cost.

The present invention has been made in view of these problems, and an object of the present invention is to provide methods for easily mass-producing spherical nanocarbon fiber assemblies, carbon nanorods, and graphene nanoribbons at low cost.

### Means for Solving the Problem

The method for producing a spherical nanocarbon fiber assembly according to an aspect of the present invention includes: freezing a dispersion liquid containing cellulose nanofibers by spraying the dispersion liquid on a brine solution to obtain a frozen product; drying the frozen product in a vacuum to obtain a dried product; and heating the dried product in an atmosphere that does not burn the dried product, thereby carbonizing the dried product to obtain a spherical nanocarbon fiber assembly.

The method for producing a carbon nanorod according to an aspect of the present invention includes crushing the spherical nanocarbon fiber assembly obtained by the above method for producing the spherical nanocarbon fiber assembly to obtain a carbon nanorod.

The method for producing the carbon nanorod according to an aspect of the present invention includes: freezing a dispersion liquid or gel containing cellulose nanofibers to obtain a frozen product: drying the frozen product in a vacuum to obtain a dried product; heating the dried product in an atmosphere that does not burn the dried product, thereby carbonizing the dried product to obtain cellulose nanofiber carbon; and crushing the cellulose nanofiber carbon to obtain a carbon nanorod.

The method for producing a graphene nanoribbon according to an aspect of the present invention includes inserting intercalators between graphite layers of the carbon nanorod obtained by the above method for producing the carbon nanorod to obtain an interlayer compound; and exfoliating each of the graphite layers of the interlayer compound to obtain a graphene nanoribbon.

### Effects of the Invention

The present invention provides methods for easily mass-producing spherical nanocarbon fiber assemblies, carbon nanorods, and graphene nanoribbons at low cost.

### BRIEF DESCRIPTION OF DRAWINGS

FIG. 1 is a flowchart illustrating a method for producing spherical nanocarbon fiber assemblies according to a first embodiment of the present invention.

FIG. 2 is a schematic diagram of the spray freezing step.

FIG. 3A is an SEM image of spherical nanocarbon fiber assemblies of the first embodiment at a magnification of 500 times.

FIG. 3B is an SEM image of spherical nanocarbon fiber assemblies of the first embodiment at a magnification of 10,000 times.

FIG. 3C is an SEM image of a nanocarbon material produced by a production method different from that of the first embodiment at a magnification of 10,000 times.

FIG. 4 is a flowchart illustrating the method for producing carbon nanorods according to a second embodiment of the present invention.

FIG. 5 is a flowchart illustrating the method for producing graphene nanoribbons according to a third embodiment of the present invention.

FIG. 6A is a schematic diagram of the exfoliation step.

FIG. 6B is a schematic diagram of graphene nanoribbons produced from carbon nanorods.

FIG. 7A is an SEM image of the spherical nanocarbon fiber assemblies of Experimental Example 1 at a magnification of 500 times.

FIG. 7B is an SEM image of the spherical nanocarbon fiber assemblies of Experimental Example 1 at a magnification of 10,000 times.

FIG. 7C is an SEM image of the carbon nanorods of Experimental Example 2 at a magnification of 100,000 times.

FIG. 7D is an SEM image of the nanocarbon material of Comparative Example 1 at a magnification of 10000 times.

FIG. 8 is a flowchart illustrating a method for producing carbon nanorods according to a fourth embodiment of the present invention.

FIG. 9A is an SEM image of the carbon nanorods of the fourth embodiment at a magnification of 100,000 times.

FIG. 9B is an SEM image of a nanocarbon material produced by a production method different from that of the fourth embodiment at a magnification of 10,000 times.

FIG. 10 is a flowchart illustrating a method for producing graphene nanoribbons according to a fifth embodiment of the present invention.

FIG. 11A is an SEM image of the nanocarbon material of Experimental Example 1 at a magnification of 500 times.

FIG. 11B is an SEM image of the nanocarbon material of Experimental Example 1 at a magnification of 10,000 times.

FIG. 11C is an SEM image of the carbon nanorods of Experimental Example 2 at a magnification of 100,000 times.

FIG. 11D is an SEM image of the carbon material of Comparative Example 1 at a magnification of 10,000 times.

FIG. 12 is a flowchart illustrating a method for producing carbon nanorods according to a sixth embodiment of the present invention.

FIG. 13 is a flowchart illustrating a method for producing graphene nanoribbons according to a seventh embodiment of the present invention.

### DESCRIPTION OF EMBODIMENTS

Embodiments of the present invention are described below with reference to the drawings.

### First Embodiment

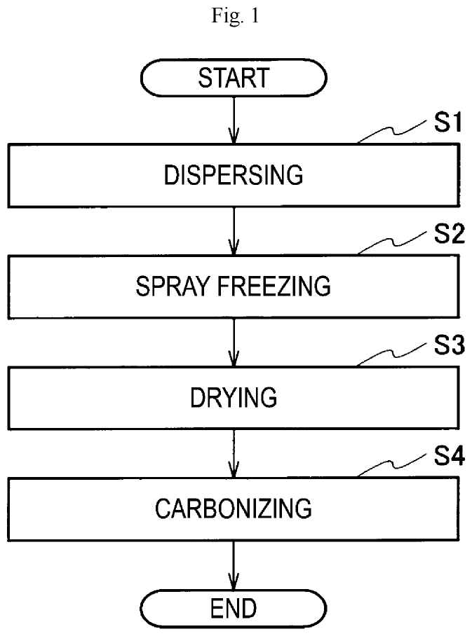

FIG. 1 is a flowchart illustrating a method for producing spherical nanocarbon fiber assemblies according to a first embodiment of the present invention.

Spherical nanocarbon fiber assemblies not only prevent the aggregation of carbon nanotubes, but also serve as catalyst supports with excellent catalytic activity, because these assemblies have a moderate pore structure and therefore have many reaction sites that can function effectively even when loaded with catalysts.

The method for producing spherical nanocarbon fiber assemblies of the present embodiment includes a dispersing step (step S1), a spray freezing step (step S2), a drying step (step S3), and a carbonizing step (step S4). This production method requires a cellulose nanofiber dispersion liquid.

The form of the cellulose nanofibers in the cellulose nanofiber dispersion liquid is preferably a dispersed form. Therefore, the production process illustrated in FIG. 1 includes the dispersing step (step S1), but the dispersing step (step S1) may be omitted. In other words, the dispersing step is not necessary when a dispersion liquid in which cellulose nanofibers are dispersed is used.

In the dispersing step, the cellulose nanofibers contained in the cellulose nanofiber dispersion liquid are dispersed. The dispersion medium includes at least one selected from the group consisting of aqueous media such as water (H2O) and organic media such as carboxylic acids, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The dispersion medium may be composed of at least one selected from the above group.

For dispersing the cellulose nanofibers, it is only required that, for example, a homogenizer, an ultrasonic cleaner, an ultrasonic homogenizer, a magnetic stirrer, a stirrer, or a shaker be used.

The solid content concentration of the cellulose nanofibers in the cellulose nanofiber dispersion liquid is preferably from 0.001 to 80% by mass, and more preferably from 0.01 to 30% by mass.

In the spray freezing step, the dispersion liquid containing cellulose nanofibers is sprayed on a brine solution and frozen, so that a frozen product is obtained (step S2). In the spray freezing step, freezing the cellulose nanofiber dispersion liquid causes the dispersion medium to lose its fluidity, thereby fixing the cellulose nanofibers being dispersoids and building a three-dimensional network structure.

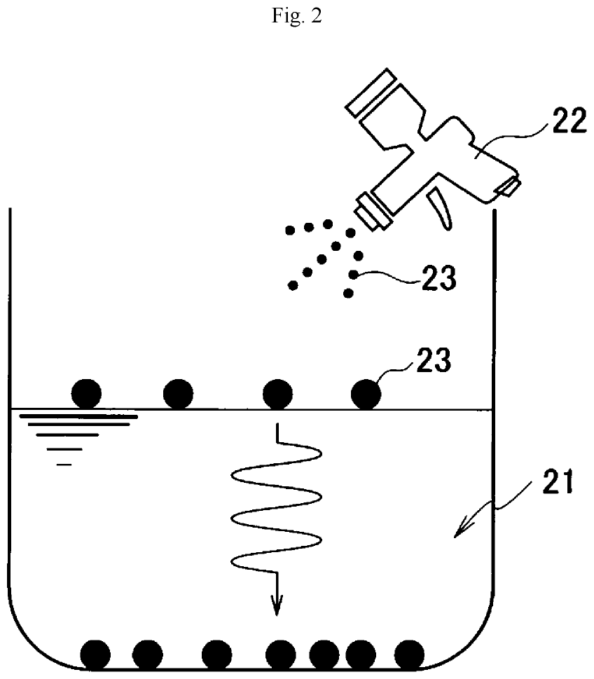

FIG. 2 is a schematic diagram of the spray freezing step. In this embodiment, a cellulose nanofiber dispersion liquid is sprayed on a brine solution 21. For spraying the cellulose nanofiber dispersion liquid, it is only required that a spray 22 such as air spray, mist spray, atomizer, blower sprayer, rotary atomizer, ultrasonic nozzle, pressure nozzle, four-fluid nozzle, or two-fluid nozzle be used.

The secondary particle size of the spherical nanocarbon fiber assemblies, described below, can be controlled by the particle size of atomized cellulose nanofibers 23. The particle size of the atomized cellulose nanofibers 23 can be adjusted by, for example, the nozzle, flow rate, or spray pressure of the spray 22 used for spraying. In the present embodiment, the atomized cellulose nanofibers 23 having a particle size corresponding to at least one of the nozzle, flow rate, or spray pressure of the spray 22 are sprayed on the brine solution 21. The particles of the atomized cellulose nanofibers 23 are spherical.

For example, when the spherical nanocarbon fiber assemblies are used as a conductive aid for batteries, a capacitor, or a conductive ink, the particle size of the atomized cellulose nanofibers 23 is set to 5 to 400 μm, thereby the secondary particle size of the spherical nanocarbon fiber assemblies obtained from the atomized cellulose nanofibers 23 is set to be from 3 to 100 μm. As a result, the spherical nanocarbon fiber assemblies can be used as an excellent nanocarbon material that has dispersibility and forms conductive paths.

The temperature of the brine solution is not particularly limited as long as the dispersion medium of the cellulose nanofiber dispersion liquid can be cooled down to the freezing point or lower. However, rapid freezing of the sprayed atomized cellulose nanofibers 23 can prevent the aggregation of cellulose nanofibers. Therefore, the temperature of the brine solution is preferably −30° C. or lower, and more preferably −50° C. or lower.

The brine solution is not particularly limited as long as it has a melting point equal to or lower than the cooling temperature. The brine solution includes, for example, at least one selected from the group consisting of ethanol, methanol, Nybrine (trade name), Etabrine (trade name), Barrel Silicone Fluid (trade name), and liquid nitrogen. The brine solution may be composed of at least one selected from the above group. Liquid nitrogen is particularly preferable because it has a low cooling temperature and vaporizes at room temperature, making it easy to collect the frozen product from the brine solution.

In the drying step, the frozen product frozen in the freezing step is dried in a vacuum, so that a dried product is obtained (step S3). In the drying step, the frozen dispersion medium sublimates from its solid state. For example, the step is performed by storing the obtained frozen product in an appropriate container such as a flask and vacuuming the inside of the container. By placing the frozen product in a vacuum atmosphere, the sublimation point of the dispersion medium decreases, so that even a substance that does not sublimate under normal pressure can sublimate.

The degree of vacuum in the drying step is different depending on the dispersion medium to be used but is not particularly limited as long as the dispersion medium sublimates at such a degree of vacuum. For example, when water is used as the dispersion medium, the degree of vacuum needs to be 0.06 MPa or less, but it takes time to dry because heat is taken away as latent heat of sublimation. Therefore, the degree of vacuum is preferably from 1.0×10⁻⁶ Pa to 1.0×10⁻² Pa. Further, heat may be applied by using a heater or the like at the time of drying.

In the carbonizing step, the dried product dried in the drying step is heated and carbonized in an atmosphere that does not burn the dried product, so that spherical nanocarbon fiber assemblies are obtained (step S4). It is only required that cellulose nanofibers be carbonized, being fired at 200° C. to 2000° C., more preferably from 600° C. to 1800° C. in an inert gas atmosphere. The gas that does not burn cellulose is only required to be, for example, an inert gas such as nitrogen gas or argon gas. Further, the gas that does not burn cellulose may be a reducing gas such as hydrogen gas or carbon monoxide gas, or may be carbon dioxide gas. Carbon dioxide gas or carbon monoxide gas is more preferable because they have activation effect on nanocarbon materials and thus are expected to highly activate nanocarbon materials.

According to the method for producing spherical nanocarbon fiber assemblies described above, in the spray freezing step, the cellulose nanofibers being dispersoids are fixed and spherical cellulose nanofiber assemblies with a three-dimensional network structure maintained are constructed. Further, in the present embodiment, spherical nanocarbon fiber assemblies are produced by spraying particles of atomized cellulose nanofibers in the spray freezing step. In this way, in the present embodiment, spherical nanocarbon fiber assemblies are easily produced at low cost without using diamond-supported catalyst. Therefore, the present embodiment provides a method for easily mass-producing spherical nanocarbon fiber assemblies at low cost.

In addition, in the present embodiment, because of the drying step, the spherical nanocarbon fiber assemblies can be taken out while the three-dimensional network structure is maintained. Therefore, in the present embodiment, a nanocarbon material (spherical nanocarbon fiber assemblies) having a sufficient specific surface area can be obtained. Further, in the present embodiment, a nanocarbon material having a high specific surface area can be easily produced.

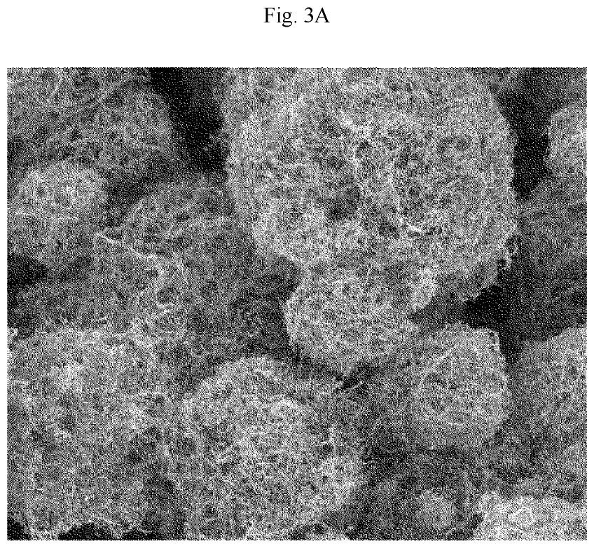

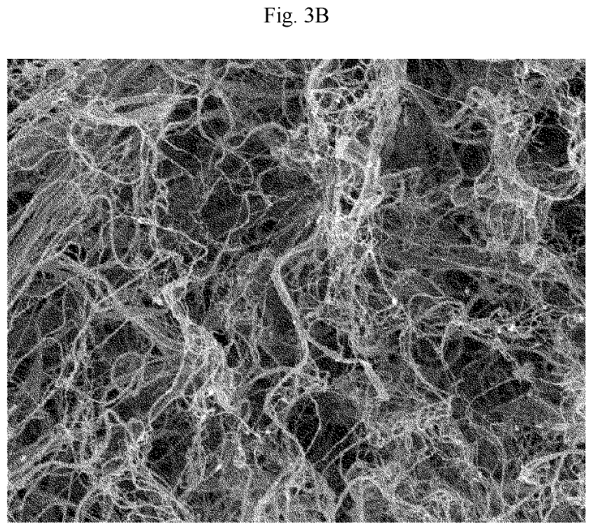

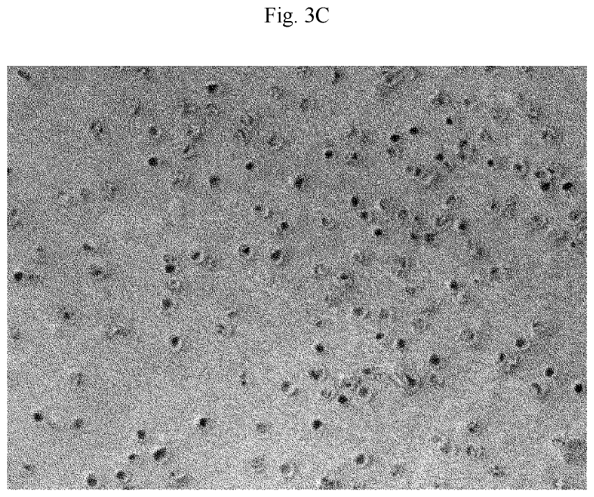

FIGS. 3A and 3B are scanning electron microscope (SEM) images of spherical nanocarbon fiber assemblies produced by the production method of the present embodiment. The magnifications of FIGS. 3A and 3B are 500 times and 10,000 times, respectively. FIG. 3A indicates that spherical nanocarbon fiber assemblies are formed. FIG. 3B indicates that the cellulose nanofiber carbon is fixed and a three-dimensional network structure is constructed.

FIG. 3C illustrates the state of cellulose nanofiber carbon when it is dried and carbonized in the air without performing the spray freezing step and the drying step of the present embodiment. The magnification of FIG. 3C is 10,000 times. When dried in the air, the three-dimensional network structure of the cellulose nanofibers is destroyed because the liquid turns into a gas. As illustrated in FIG. 3C, if the three-dimensional network structure is destroyed, it is difficult to produce a nanocarbon material having a high specific surface area.

As described above, the spherical nanocarbon fiber assemblies produced by the production method of the present embodiment have a three-dimensional network structure of co-continuum due to the branching of cellulose nanofiber carbon, and are spherical. Further, the spherical nanocarbon fiber assemblies of the present embodiment have high conductivity, corrosion resistance, and a high specific surface area.

Therefore, the spherical nanocarbon fiber assemblies produced by the production method of the present embodiment are suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbing materials, heating elements, microwave heating elements, cone paper, clothes, carpets, mirror fogging prevention materials, sensors, and touch panels.

### Second Embodiment

In a second embodiment, carbon nanorods are produced from the spherical nanocarbon fiber assemblies obtained in the first embodiment. The carbon nanorod is a rod-shaped nanocarbon material that is not hollow.

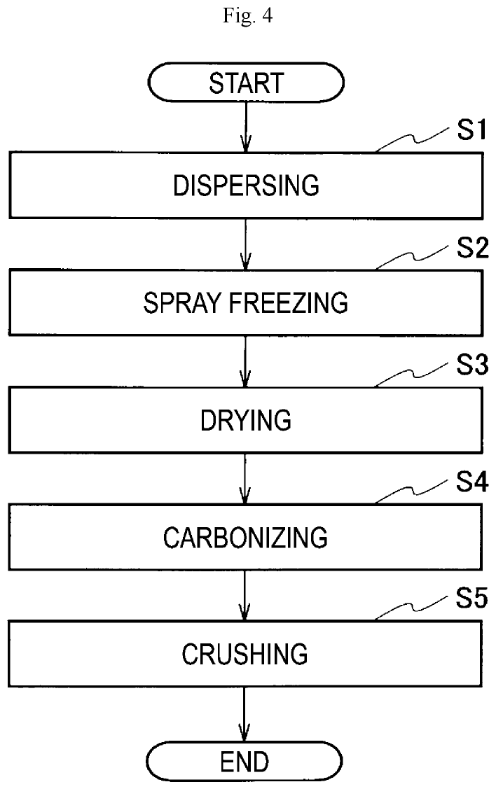

FIG. 4 is a flowchart illustrating a method for producing carbon nanorods according to the second embodiment. The production method illustrated in FIG. 4 further includes a crushing step (step S5) in the production method of the first embodiment. That is, the method for producing carbon nanorods of the present embodiment includes a crushing step of crushing the spherical nanocarbon fiber assemblies obtained in the first embodiment to obtain carbon nanorods (nanocarbon material). Since the steps S1 to S4 are the same as those in the first embodiment, description thereof will be omitted here.

In the crushing step, the dried product (spherical nanocarbon fiber assemblies) carbonized in the above carbonizing step (step S4) is crushed (step S5). In the crushing step, the spherical nanocarbon fiber assemblies are crushed into powder or slurry using, for example, a mixer, a homogenizer, an ultrasonic homogenizer, a high-speed rotary shear type stirrer, a colloid mill, a roll mill, a high-pressure injection disperser, a rotary ball mill, a vibrating ball mill, a planetary ball mill, or an attritor. The crushing method includes a wet crushing method and a dry crushing method, and a wet crushing method capable of more uniform and fine crushing is preferable.

The solvent used in the wet crushing method is not particularly limited, and includes at least one selected from, for example, the group consisting of aqueous solvents such as water (H2O) and organic solvents such as carboxylic acid, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The solvent may be composed of at least one selected from the above group.

The rod length of carbon nanorods is preferably from 10 nm to 400 nm, and more preferably from 50 nm to 200 nm. The reason for this is that when the carbon nanorods are crushed until the rod length becomes 10 nm or less, the aspect ratio (rod length/rod width) of the carbon nanorods becomes small, and the specificity due to the shape of the carbon nanorods is lost. Further, when the length of the carbon nanorods is 400 nm or more, the branched structure of the spherical nanocarbon fiber assemblies remains, which makes it difficult to produce carbon nanorods. Specifically, carbon nanorods are cylindrical, but if they have branches, they no longer have a cylindrical shape. That is, if branches remain, it becomes difficult to produce cylindrical carbon nanorods.

For example, when carbon nanorods with a rod length of 10 nm to 400 nm are used in, for example, a conductive aid for batteries, a capacitor, or a conductive ink, carbon nanorods enter the voids generated between granular active materials or between silver powders to form excellent conductive paths.

The present embodiment provides a method for easily mass-producing carbon nanorods at low cost by using the spherical nanocarbon fiber assemblies obtained by the production method of the first embodiment.

### Third Embodiment

In a third embodiment, the carbon nanorods obtained in the second embodiment are unraveled into graphene, so that graphene nanoribbons are produced. Graphene nanoribbon is a ribbon-shaped nanocarbon material composed of monatomic-thick graphene (graphite layer, thin carbon film), which constitutes graphite.

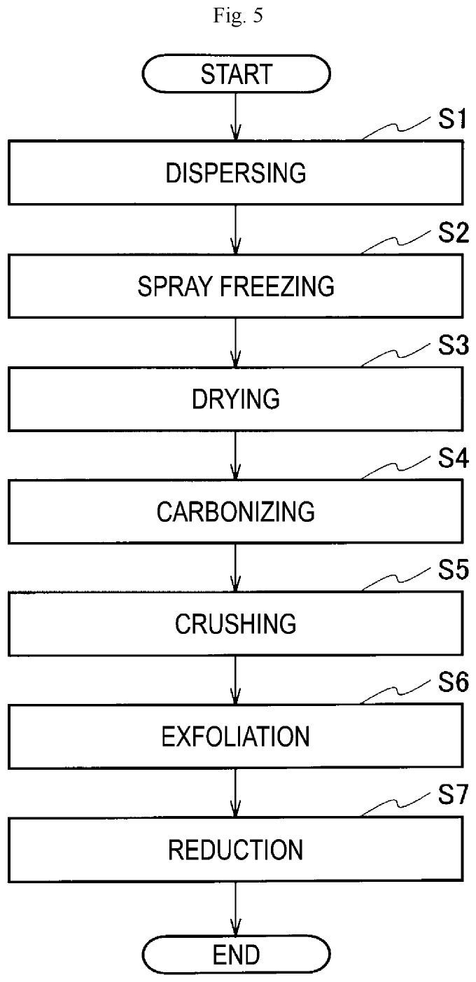

FIG. 5 is a flowchart illustrating the method for producing graphene nanoribbons according to the third embodiment. The production method illustrated in FIG. 5 further includes an exfoliation step (step S6) and a reduction step (step S7) in the production method of the second embodiment. That is, in the method for producing carbon nanorods of the present embodiment, the carbon nanorods obtained in the second embodiment are subjected to an exfoliation step and a reduction step described later, so that graphene nanoribbons (nanocarbon material) are obtained. Since the steps S1 to S5 are the same as those in the first and second embodiments, description thereof will be omitted here.

In the exfoliation step, the graphite layers of the carbon nanorods crushed in the above crushing step (step S5) are exfoliated (step S6).

The exfoliation step is not particularly limited as long as the graphite layers of the carbon nanorods can be exfoliated. For example, the exfoliation can be progressed by performing ultrasonic irradiation, microwave irradiation, oxidation treatment, or heat treatment after intercalators are inserted between the graphite layers of carbon nanorods to weaken the bonding force between the layers. In this case, the exfoliation step includes an insertion step in which the intercalators are inserted between the graphite layers of carbon nanorods, so that an interlayer compound is obtained. The interlayer compound is a carbon nanorod in which the intercalators are inserted.

Here, the “intercalator” refers to an interstitial substance such as an atom, ion, or molecule that is inserted between graphene and graphene (between graphite layers) constituting the carbon.

The intercalator is not limited as long as it can be inserted between graphite layers. The intercalator includes, for example, at least one selected from the group consisting of: single metal atoms such as K, Rb, Cs, Li, Ca, Sr, Ba, Sm, Eu, and Yb; halogen molecules such as Br₂, I₂, Cl₂, and ICI; fluorides containing Kr, B, P, Cl, Br, Si, Ti, Xe, P, As, Sb, Nb, Ta, I, Mo, W, or U; chlorides containing Mg, Zn, Cd, Hg, Mn, Fe, Co, Ni, Pd, Cu, B, Al, Ga, In, Tl, Cr, Fe, Ru, Os, Au, Y, Sm, Eu, Gd, Tb, Dy, Ho, Er, Tm, Yb, Lu, Zr, Hf, Sb, Bi, Nb, Ta, Mo, U, Te, or W; bromides containing Cd, Hg, Fe, Al, Ga, Tl, Fe, Au, or U; oxides such as N₂O₅, SO₃, SeO₃, CrO₃, MoO₃, Cl₂O₇, Re₂O₇, and P₄O₁₀; and acids such as HNO₃, H₂SO₄, HClO₄, H₃PO₄, HF, and CF₃COOH. The intercalator may be composed of at least one selected from the above group.

The insertion method for inserting the intercalators between graphite layers is not particularly limited, and examples thereof include a method in which intercalators in a gas phase are reacted with carbon (gas phase method), a method in which intercalators in a liquid phase are reacted with carbon (liquid phase method), and a method in which intercalators in a solid phase are reacted with carbon (solid phase method). The liquid phase method is preferable because it can be carried out at room temperature, the reaction rate is high, and it allows mass production.

Specifically, in the liquid phase method, it is only required that a solution containing intercalators and carbon nanorods be mixed. For mixing, it is only required that, for example, a homogenizer, an ultrasonic cleaner, an ultrasonic homogenizer, a magnetic stirrer, a stirrer, or a shaker be used.

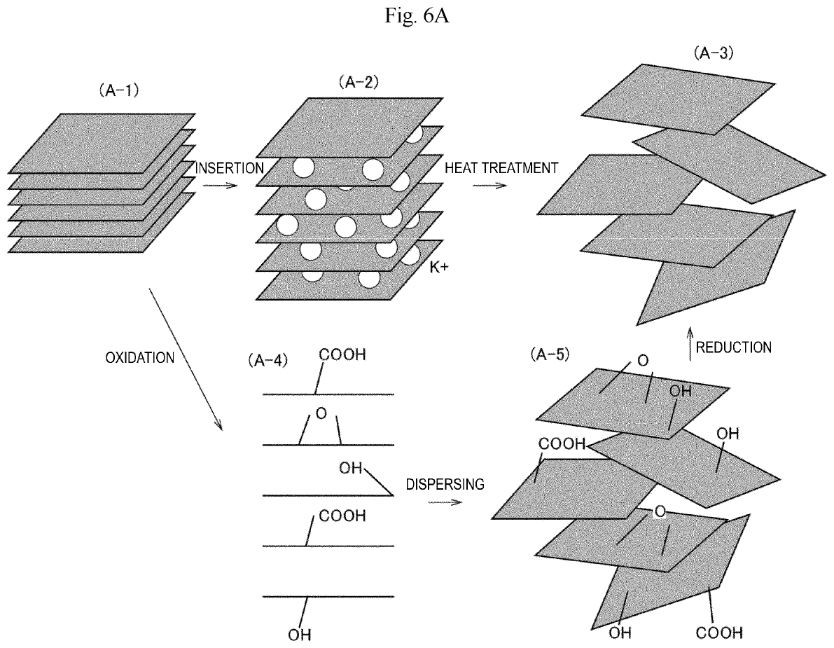

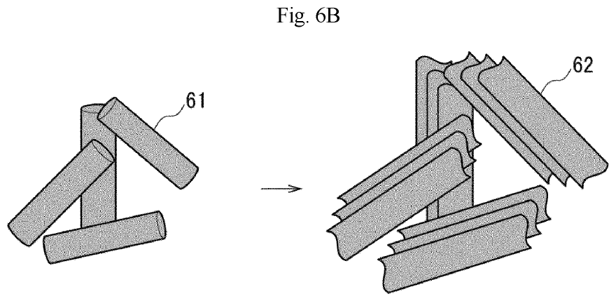

FIG. 6A is a schematic diagram of an example of insertion of potassium ions as an intercalator. FIG. 6A illustrates not only the exfoliation step by insertion of the intercalators ((A-1), (A-2), and (A-3)) but also the exfoliation step by oxidation described later.

First, carbon nanorods (A-1) are impregnated with a 0.1 mol/L aqueous potassium hydroxide solution and dispersed with ultrasonic waves for 1 hour to insert potassium ions K⁺ between graphite layers, so that an interlayer compound is obtained (A-2). Thereafter, the carbon nanorods in which potassium ions K⁺ are inserted are heat-treated at 800° C. for 2 hours in an argon atmosphere, thereby exfoliating the carbon nanorods (A-3).

The production process illustrated in FIG. 5 includes a reduction step (step 7), but the reduction step (step 7) may be omitted. That is, when the exfoliated product obtained by the insertion of the intercalators in the above exfoliation step is graphene nanoribbon, the reduction step is not necessary.

In the exfoliation step, exfoliation can be progressed by performing ultrasonic irradiation, microwave irradiation, oxidation treatment, or heat treatment after the graphite of carbon nanorods is oxidized and the bonding force between the layers is weaken. When graphite is oxidized and graphite layers are exfoliated, the exfoliated product is graphene oxide nanoribbon. Therefore, the graphene oxide nanoribbons need to be reduced to graphene nanoribbons by performing chemical reduction, electro-reduction, thermal reduction, or photo-irradiation in the reduction step (step 7).

The method for oxidizing graphite is not particularly limited, but may be a chemical oxidation method such as a Brodie method, a Staudenmaier method, or a Hummers method, or an electrochemical method.

The schematic diagrams in FIG. 6A ((A-1), (A-4), (A-5), and (A-3)) illustrate an example of the exfoliation and reduction steps after graphite is oxidized by the Brodie method.

First, carbon nanorods (A-1) are stirred in concentrated nitric acid for 5 hours, and then graphite is oxidized by adding potassium chlorate as an oxidant (A-4). As a result, functional groups are bonded to the graphite layers. Not all of the functional groups bonded by oxidation are reduced by the reduction step described below. Therefore, the amount of functional groups in graphene nanoribbons after the oxidation step increases compared to spherical nanocarbon fiber assemblies that do not undergo the oxidation step. The oxidized graphite is dispersed by ultrasound for one hour, and the carbon nanorods are exfoliated, so that an exfoliated product is obtained (A-5). Since the exfoliated product is graphene oxide nanoribbons, graphene nanoribbons are obtained by reducing the graphene oxide nanoribbons in an argon atmosphere at 1100° C. for 5 minutes (A-3).

FIG. 6B is a schematic diagram of graphene nanoribbons produced from carbon nanorods. A single carbon nanorod 61 is exfoliated to produce a plurality of graphene nanoribbons 62.

The graphene nanoribbons produced by this production method have excellent specific surface area because they are produced by exfoliating carbon nanorods. Therefore, when they are used, for example, in capacitors, they have a large number of reaction sites, and thus have an excellent energy density.

The present embodiment also provides a method for easily mass-producing graphene nanoribbons at low cost by using the carbon nanorods obtained by the production method of the second embodiment.

For the purpose of confirming the effects of the production methods of the first, second, and third embodiments described above, an experiment was carried out in which the nanocarbon materials produced by the production methods of these embodiments (Experimental Examples 1 to 3) were compared with the nanocarbon materials produced by production methods different from those of the above embodiments (Comparative Examples 1 and 2).

### Experimental Example 1

The nanocarbon material of Experimental Example 1 is a spherical nanocarbon fiber assembly produced in the first embodiment. In Experimental Example 1, 1 g of cellulose nanofibers (manufactured by Nippon Paper Industries Co., Ltd.) and 10 g of ultrapure water were stirred in a homogenizer (manufactured by SMT Co., Ltd.) for 12 hours, so that a dispersion liquid of cellulose nanofibers was prepared.

The dispersion liquid of cellulose nanofibers above was air sprayed into liquid nitrogen (brine solution), and thus the cellulose nanofiber dispersion liquid was completely frozen. After the cellulose nanofiber dispersion liquid was completely frozen, the frozen cellulose nanofiber dispersion liquid was collected and dried in a vacuum of 10 Pa or less using a freeze dryer (manufactured by Tokyo Rikakikai Co., Ltd.), so that a dried product of cellulose nanofibers was obtained. After drying in a vacuum, the cellulose nanofibers were fired at 1200° C. for 2 hours in a nitrogen atmosphere and thus carbonized, thereby producing the nanocarbon material (spherical nanocarbon fiber assemblies) of Experimental Example 1.

### Experimental Example 2

The nanocarbon material of Experimental Example 2 is the carbon nanorod produced in the second embodiment. In Experimental Example 2, in a crushing step, the nanocarbon material produced in Experimental Example 1 was impregnated with water and then crushed with a ball mill (manufactured by Nidec-Shimpo Corporation) using zirconia balls with a diameter of 0.8 mm to 1.0 mm at a rotation speed of 60 r/min for 72 hours. The crushed object was then dried using a hot plate at 80° C. for 12 hours, and thus the water as dispersion medium was evaporated, thereby producing the nanocarbon material (carbon nanorods) of Experimental Example 2.

### Experimental Example 3

The nanocarbon material of Experimental Example 3 is the graphene nanoribbon produced in the third embodiment. In Experimental Example 3, the nanocarbon material produced in Experimental Example 2 was stirred in a mixed acid of concentrated nitric acid and concentrated sulfuric acid (concentrated nitric acid:concentrated sulfuric acid=1:2) for 5 hours using a magnetic stirrer. After that, potassium chlorate was added, stirring was continued for 5 hours, and then the liquid mixture was suction-filtered while diluted with water. The exfoliated object collected from the filter paper was placed in a constant temperature bath and dried at 60° C. for 12 hours, followed by reduction treatment at 1100° C. for 5 minutes in an argon atmosphere, thereby producing the nanocarbon material (graphene nanoribbons) of Experimental Example 3.

### Comparative Example 1

The nanocarbon material of Comparative Example 1 is a nanocarbon material produced by normal drying without undergoing the spray freezing and drying steps of Experimental Example 1.

In Comparative Example 1, the cellulose nanofiber dispersion liquid prepared in Experimental Example 1 was poured into a petri dish, placed in a constant temperature bath, and dried at 60° C. for 12 hours. Then, the cellulose nanofibers were fired at 1200° C. for 2 hours in a nitrogen atmosphere and thus carbonized, thereby producing a nanocarbon material.

### Evaluation Method

The nanocarbon materials obtained in Experimental Examples and Comparative Examples were evaluated by XRD measurement, SEM observation, BET specific surface area measurement, and NMR measurement. These nanocarbon materials were confirmed to be single phase carbon (C, PDF card No. 01-071-4630) through XRD measurement. The PDF card No. is a card number of Powder Diffraction File (PDF), which is a database collected by the International Centre for Diffraction Data (ICDD).

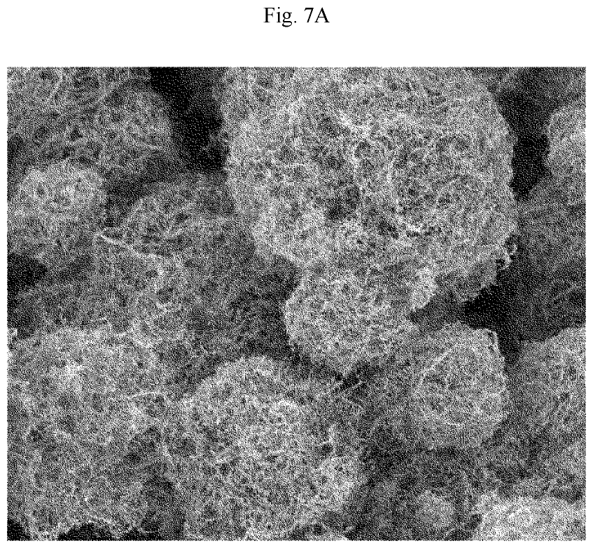

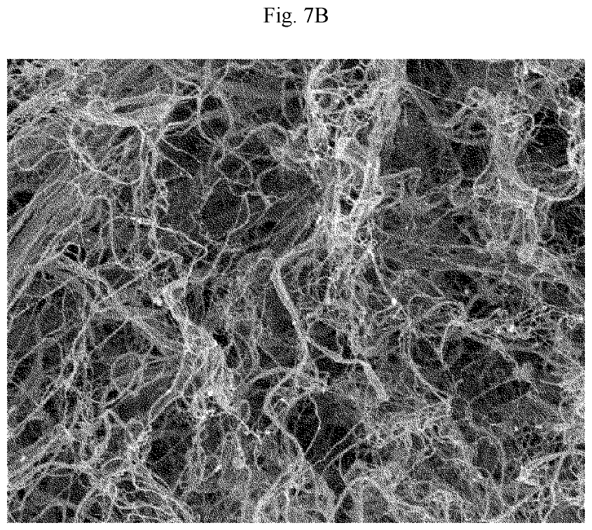

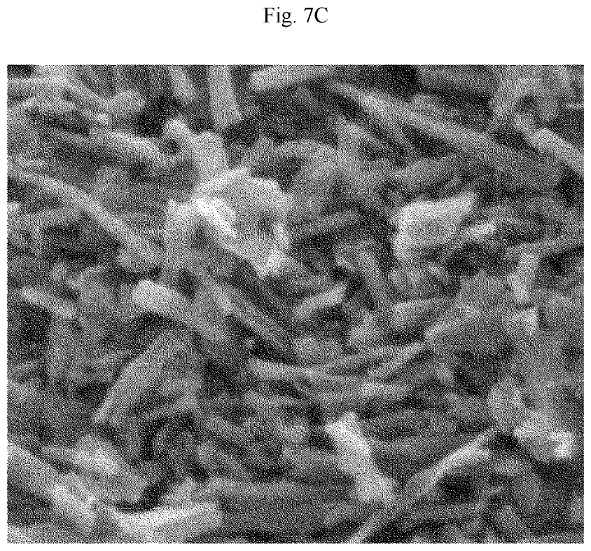

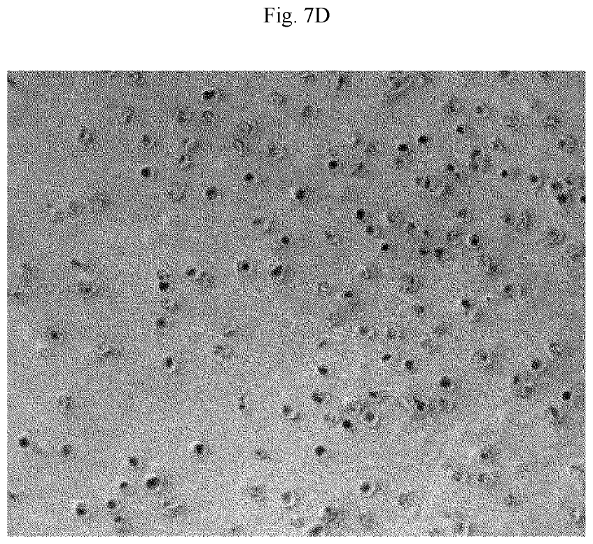

FIGS. 7A to 7F illustrate the SEM images of the produced nanocarbon materials. Table 1 shows the evaluation values obtained by the measurement.

FIG. 7A is an SEM image of the nanocarbon material obtained in Experimental Example 1 at a magnification of 500 times. FIG. 7B is an SEM image of the nanocarbon material obtained in Experimental Example 1 at a magnification of 10,000 times. FIG. 7C is an SEM image of the nanocarbon material obtained in Experimental Example 2 at a magnification of 100,000 times.

FIG. 7D is an SEM image of the nanocarbon material obtained in Comparative Example 1 at a magnification of 10,000 times.

As illustrated in FIGS. 7A and 7B, it can be confirmed that the nanocarbon material of Experimental Example 1 (first embodiment) is a spherical co-continuum in which nanofiber carbon having a fiber diameter of several tens of nm are continuously connected. That is, in this nanocarbon material, the nanofiber carbon constructs a three-dimensional network structure.

As illustrated in FIG. 7C, the nanocarbon material in Experimental Example 2 (second embodiment) is confirmed to be carbon nanorods with a rod length of several tens of nm.

On the other hand, as illustrated in FIG. 7D, it can be confirmed that the nanocarbon material obtained by performing normal drying on the cellulose nanofiber solution of Comparative Example 1 is a densely aggregated nanocarbon material having no pores.

As indicated in Table 1, the nanocarbon material (spherical nanocarbon fiber assemblies) of Experimental Example 1 (first embodiment) can suppress the aggregation caused by the surface tension of water due to the evaporation of the dispersion medium as compared with Comparative Example 1 in which normal drying was performed. As a result, it was confirmed that it was possible to provide a nanocarbon material having excellent performance with a high specific surface area and a large total pore volume.

The average secondary particle size is a value calculated from the SEM image by selecting 10 locations having a range of 200 μm×200 μm.

The average rod length, the average ribbon width, and the average ribbon length are values calculated from the SEM image by selecting 10 locations having the range of 5 μm×5 μm.

The specific surface area and total pore volume were measured by the gas adsorption method, and the total pore volume was calculated by the BJH method.

TABLE 1

| Experimental Example/ | | Specific Surface | | Total Pore | Functional Group |
|---|---|---|---|---|---|
| Comparative Example | SEM Observation Result | Area | | Volume | Amount |
| Experimental Example 1 | Spherical nanocarbon fiber | 780 | m²/g | 0.97 cm³/g | 8% |
| | assemblies with a secondary | | | | |
| | particle diameter of 60 μmφ and | | | | |
| | a fiber diameter of 20 nmφ | | | | |
| Experimental Example 2 | Carbon nanorods with an average | 900 | m²/g | 0.25 cm³/g | 9% |
| | rod length of 80 nm | | | | |
| Experimental Example 3 | Graphene nanoribbons with an | 1500 | m²/g | 0.10 cm³/g | 15% |
| | average ribbon width of 20 nm | | | | |
| | and an average ribbon length of | | | | |
| | 80 nm | | | | |
| Comparative Example 1 | Aggregated carbon material | 5 | m²/g | 0.02 cm³/g | 5% |
| | without pores | | | | |

In Experimental Examples 1, 2, and 3 in Table 1, it was confirmed that the amounts of functional groups were 8 at %, 9 at %, and 15 at %, respectively. In the measurement of the amount of functional groups, the dipolar chemistry/magic angle spinning (DD/MAS) method of solid ¹³C NMR measurement was applied, 1.6 ppm of polydimethylsiloxane was mixed for axis correction, and the carbon fraction of each component was calculated from the peak area of each chemical shift value.

Since the amount of functional groups of the related-art nanocarbon materials is 1 at % or less, the nanocarbon material produced in the present embodiment has a large amount of functional groups and has excellent hydrophilicity. Further, from the results of NMR measurement, it was found that these functional groups were derived from cellulose and were hydroxy group (—OH), carboxy group (—COOH), aldehyde group (—CHO), carbonyl group (>CO), ether (—O—), ester bond (—COO—), alkyl group, vinyl group (CH₂═CH—), and aryl group. In particular, the hydroxy group (—OH) and carboxy group (—COOH) have strong hydrophilicity, which is considered to be a factor in the excellent hydrophilicity of the nanocarbon material produced in the present embodiment.

As described above, the production method of the present embodiment includes: a spray freezing step of freezing a dispersion liquid containing cellulose nanofibers by spraying the dispersion liquid on a brine solution to obtain a frozen product; a drying step of drying the frozen product in a vacuum to obtain a dried product; and a carbonizing step of heating and carbonizing the dried product in an atmosphere of gas that does not burn the dried product. In the present embodiment, the cellulose nanofibers are spray-frozen and then carbonized through heat treatment, which results in excellent specific surface area and porosity.

The nanocarbon materials produced by the production methods of the first, second, and third embodiments may be produced using naturally derived cellulose, the environmental load of which is extremely low. Since these nanocarbon materials are easily disposable in daily life, they can be effectively used in various situations such as small devices, sensor terminals, medical equipment, batteries, beauty appliances, fuel cells, biofuel cells, microbial batteries, capacitors, catalysts, solar cells, semiconductor production processes, filters, heat resistant materials, flame resistant materials, heat insulating materials, conductive materials, electromagnetic wave shield materials, electromagnetic wave noise absorbents, heating elements, microwave heating elements, cone paper, clothes, carpet, mirror anti-fog materials, sensors, and touch panels.

### Fourth Embodiment

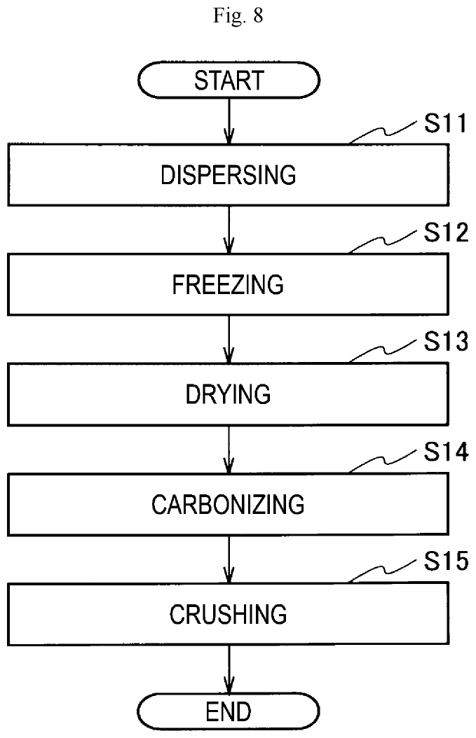

FIG. 8 is a flowchart illustrating a method for producing the carbon nanorods according to a fourth embodiment. In the present embodiment, the cellulose nanofiber carbon is crushed to produce carbon nanorods (nanocarbon material). The cellulose nanofiber carbon is produced by performing the “freezing step” described below instead of the “spray freezing step” of the first embodiment.

The method for producing carbon nanorods of the present embodiment includes a dispersing step (step S11), a freezing step (step S12), a drying step (step S13), a carbonizing step (step S14), and a crushing step (step S15). This production method requires a cellulose nanofiber dispersion liquid.

The form of the cellulose nanofibers in the cellulose nanofiber dispersion liquid is preferably a dispersed form. Therefore, the production process illustrated in FIG. 8 includes the dispersing step (step S11), but the dispersing step (step S11) may be omitted. In other words, the dispersing step is not necessary when a dispersion liquid in which cellulose nanofibers are dispersed is used.

In the dispersing step, the cellulose nanofibers contained in the cellulose nanofiber dispersion liquid are dispersed. The dispersion medium includes at least one selected from the group consisting of aqueous media such as water (H2O) and organic media such as carboxylic acids, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The dispersion medium may be composed of at least one selected from the above group.

For dispersing the cellulose nanofibers, it is only required that, for example, a homogenizer, an ultrasonic cleaner, an ultrasonic homogenizer, a magnetic stirrer, a stirrer, or a shaker be used.

The solid content concentration of the cellulose nanofibers in the cellulose nanofiber dispersion liquid is preferably from 0.001 to 80% by mass, and more preferably from 0.01 to 30% by mass.

In the freezing step, a solution containing the cellulose nanofibers is frozen, so that a frozen product is obtained (step S12). In the freezing step, for example, the cellulose nanofiber solution is put in an appropriate container such as a test tube, and the cellulose nanofibers are frozen in the test tube by cooling the surroundings of the test tube in a coolant such as liquid nitrogen.

The freezing method is not particularly limited as long as the dispersion medium of the solution can be cooled to a temperature equal to or lower than the solidifying point, and the dispersion medium may be cooled in a freezer or the like. By freezing the cellulose nanofiber solution, the dispersion medium loses its fluidity, the cellulose nanofibers being dispersoids are fixed, and a three-dimensional network structure is constructed.

In the drying step, the frozen product frozen in the freezing step is dried in a vacuum, so that a dried product is obtained (step S13). In the drying step, the frozen dispersion medium sublimates from its solid state. For example, the step is performed by storing the obtained frozen product in an appropriate container such as a flask and vacuuming the inside of the container. By placing the frozen product in a vacuum atmosphere, the sublimation point of the dispersion medium decreases, so that even a substance that does not sublimate under normal pressure can sublimate.

The degree of vacuum in the drying step is different depending on the dispersion medium to be used but is not particularly limited as long as the dispersion medium sublimates at such a degree of vacuum. For example, when water is used as the dispersion medium, the degree of vacuum needs to be 0.06 MPa or less, but it takes time to dry because heat is taken away as latent heat of sublimation. Therefore, the degree of vacuum is preferably from 1.0×10⁻⁶ Pa to 1.0×10⁻² Pa. Further, heat may be applied by using a heater or the like at the time of drying.

In the carbonizing step, the dried product dried in the drying step is heated and carbonized in an atmosphere that does not burn the dried product, so that cellulose nanofiber carbon (step S14) is obtained. It is only required to that cellulose nanofibers be carbonized, being fired at 200° C. to 2000° C., more preferably from 600° C. to 1800° C. in an inert gas atmosphere. The gas that does not burn cellulose is only required to be, for example, an inert gas such as nitrogen gas or argon gas. Further, the gas that does not burn cellulose may be a reducing gas such as hydrogen gas or carbon monoxide gas, or may be carbon dioxide gas. Carbon dioxide gas or carbon monoxide gas is more preferable because they have activation effect on nanocarbon materials and thus are expected to highly activate nanocarbon materials.

In the crushing step, the dried product (cellulose nanofiber carbon) carbonized in the above carbonizing step (step S14) is crushed (step S15). In the crushing step, the cellulose nanofiber carbon is crushed into powder or slurry using, for example, a mixer, a homogenizer, an ultrasonic homogenizer, a high-speed rotary shear type stirrer, a colloid mill, a roll mill, a high-pressure injection disperser, a rotary ball mill, a vibrating ball mill, a planetary ball mill, or an attritor. The crushing method includes a wet crushing method and a dry crushing method, and a wet crushing method capable of more uniform and fine crushing is preferable.

The solvent used in the wet crushing method is not particularly limited, and includes at least one selected from, for example, the group consisting of aqueous solvents such as water (H2O) and organic solvents such as carboxylic acid, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The solvent may be composed of at least one selected from the above group.

The rod length of carbon nanorods is preferably from 10 nm to 400 nm, and more preferably from 50 nm to 200 nm. The reason for this is that when the carbon nanorods are crushed until the rod length becomes 10 nm or less, the aspect ratio (rod length/rod width) of the carbon nanorods becomes small, and the specificity due to the shape of the carbon nanorods is lost. Further, when the length of the carbon nanorods is 400 nm or more, the branched structure of the cellulose nanofiber carbon remains, which makes it difficult to produce carbon nanorods.

According to the method for producing carbon nanorods described above, in the freezing step, the cellulose nanofibers being dispersoids are fixed and cellulose nanofibers with a three-dimensional network structure maintained are constructed. In addition, because of the drying step, cellulose nanofibers can be taken out while the three-dimensional network structure is maintained. By carbonizing while maintaining this three-dimensional network structure and crushing the branched structure, it becomes easy to produce carbon nanorods having a high specific surface area. Therefore, the present embodiment provides a method for easily mass-producing carbon nanorods at low cost.

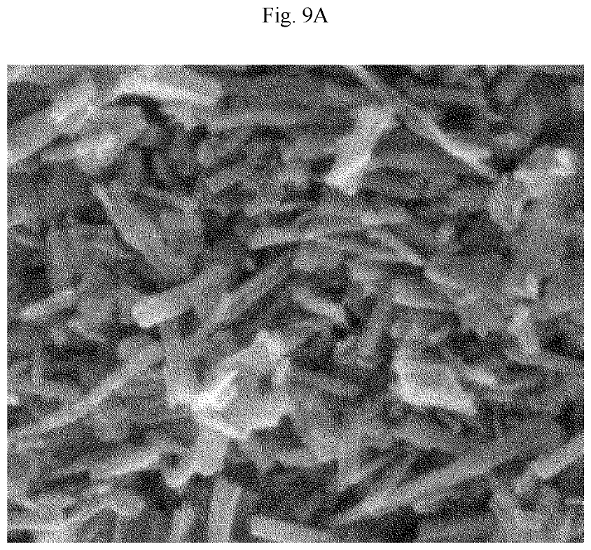

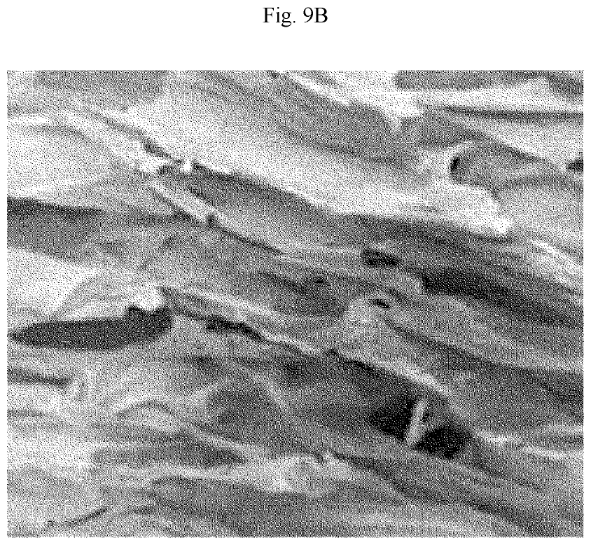

FIG. 9A is an SEM image of carbon nanorods produced by the production method of the present embodiment. The magnification of FIG. 9A is 100,000 times. This image indicates that rod-shaped carbon is produced.

FIG. 9B illustrates the cellulose nanofiber carbon dried and carbonized in the air, different from the production method of the present embodiment. The magnification of FIG. 9B is 10,000 times. When dried in the air, the three-dimensional network structure of the cellulose nanofibers is destroyed because the liquid turns into a gas. As illustrated in FIG. 29, if the three-dimensional network structure is destroyed, it is difficult to produce a nanocarbon material having a high specific surface area.

As described above, the carbon nanorods produced by the production method of the present embodiment have a structure with a fiber diameter of several tens of nm and a rod length of about five times the fiber diameter, and have high electrical conductivity, corrosion resistance, and high specific surface area.

Therefore, the carbon nanorods produced by the production method of the present embodiment are suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbing materials, heating elements, microwave heating elements, cone paper, clothes, carpets, mirror fogging prevention materials, sensors, and touch panels.

### Fifth Embodiment

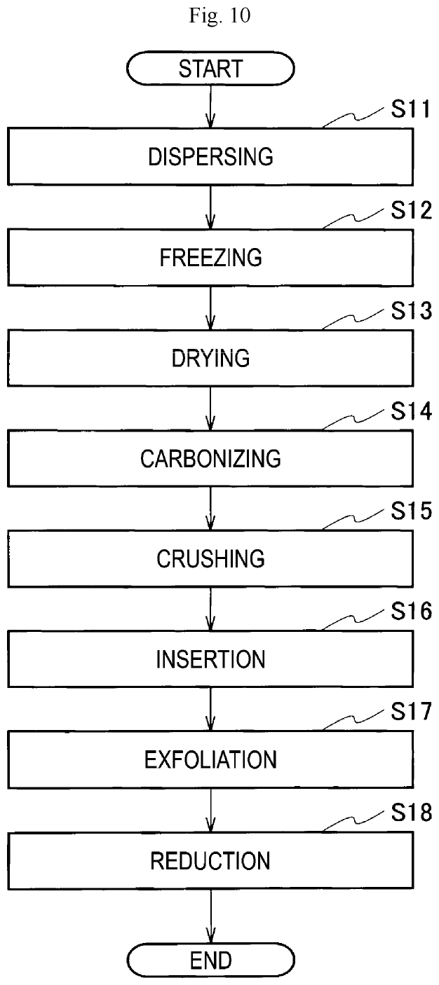

FIG. 10 is a flowchart illustrating the method for producing graphene nanoribbons according to a fifth embodiment. The production method illustrated in FIG. 10 further includes an insertion step (step S16), an exfoliation step (step S17), and a reduction step (step S18) in the production method of the fourth embodiment. That is, in the method for producing graphene nanoribbons of the present embodiment, the carbon nanorods obtained in the fourth embodiment are subjected to an insertion step, an exfoliation step, and a reduction step described later, so that graphene nanoribbons (nanocarbon material) are obtained. Since the steps S11 to S15 are the same as those in the fourth embodiment, description thereof will be omitted here.

In the insertion step, intercalators are inserted between the graphite layers of the carbon nanorods crushed in the above crushing step (step S15), so that an interlayer compound is obtained (step S16). The interlayer compound is a carbon nanorod in which the intercalators are inserted. Here, the “intercalator” refers to an interstitial substance such as an atom, ion, or molecule that is inserted between graphene and graphene (between graphite layers) constituting carbon.

The intercalator is not limited as long as it can be inserted between graphite layers. The intercalator includes, for example, at least one selected from the group consisting of: single metal atoms such as K, Rb, Cs, Li, Ca, Sr, Ba, Sm, Eu, and Yb; halogen molecules such as Br₂, I₂, Cl₂, and ICI; fluorides containing Kr, B, P, Cl, Br, Si, Ti, Xe, P, As, Sb, Nb, Ta, I, Mo, W, or U; chlorides containing Mg, Zn, Cd, Hg, Mn, Fe, Co, Ni, Pd, Cu, B, Al, Ga, In, Tl, Cr, Fe, Ru, Os, Au, Y, Sm, Eu, Gd, Tb, Dy, Ho, Er, Tm, Yb, Lu, Zr, Hf, Sb, Bi, Nb, Ta, Mo, U, Te, or W; bromides containing Cd, Hg, Fe, Al, Ga, Tl, Fe, Au, or U; oxides such as N₂O₅, SO₃, SeO₃, CrO₃, MoO₃, Cl₂O₇, Re₂O₇, and P₄O₁₀; and acids such as HNO₃, H₂SO₄, HClO₄, H3PO₄, HF, and CF₃COOH. The intercalator may be composed of at least one selected from the above group.

The method for inserting the intercalators between graphite layers is not particularly limited, and examples thereof include a method in which intercalators in a gas phase are reacted with carbon (gas phase method), a method in which intercalators in a liquid phase are reacted with carbon (liquid phase method), and a method in which intercalators in a solid phase are reacted with carbon (solid phase method). The liquid phase method is preferable because it can be carried out at room temperature, the reaction rate is high, and it allows mass production.

Specifically, in the liquid phase method, it is only required that a solution containing intercalators and carbon nanorods be mixed. For mixing, it is only required that, for example, a homogenizer, an ultrasonic cleaner, an ultrasonic homogenizer, a magnetic stirrer, a stirrer, or a shaker be used.

In the exfoliation step, the graphite layers of the interlayer compound produced in the above insertion step (step 16) are exfoliated into individual layers (step S17). The interlayer compound is a carbon nanorod in which the intercalators are inserted.

The exfoliation step is not particularly limited as long as the interlayer compound can be exfoliated into individual layers, and the exfoliation can be progressed by performing, for example, ultrasonic irradiation, microwave irradiation, oxidation treatment, or heat treatment.

The production process illustrated in FIG. 10 includes a reduction step (step 18), but the reduction step (step 18) may be omitted. That is, when the exfoliated product obtained in the above exfoliation step is a graphene nanoribbon, the reduction step is not necessary.

In the exfoliation step, when the interlayer compound is exfoliated into individual layers, the exfoliated product may be graphene oxide nanoribbons. In this case, the graphene oxide nanoribbons can be reduced to graphene nanoribbons by performing chemical reduction, electrical reduction, heat treatment reduction, light irradiation, or the like in the reduction step (step 8).

The present embodiment provides a method for easily mass-producing graphene nanoribbons at low cost by using the carbon nanorods obtained by the production method of the fourth embodiment.

For the purpose of confirming the effects of the production methods of the fourth embodiment described above and a 52nd embodiment, an experiment was carried out in which the nanocarbon materials produced by the production methods of the fourth and fifth embodiments (Experimental Examples 1 to 3) were compared with the nanocarbon material produced by a production method different from those of the above embodiments (Comparative Example 1).

### Experimental Example 1

The nanocarbon material of Experimental Example 1 is the cellulose nanofiber carbon produced in the fourth embodiment. In Experimental Example 1, 1 g of cellulose nanofibers (manufactured by Nippon Paper Industries Co., Ltd.) and 10 g of ultrapure water were stirred in a homogenizer (manufactured by SMT Co., Ltd.) for 12 hours, so that a dispersion liquid of cellulose nanofibers was prepared. The liquid was then poured into a test tube.

The cellulose nanofiber dispersion liquid was completely frozen by immersing the test tube in liquid nitrogen for 30 minutes. After completely freezing the cellulose nanofiber dispersion liquid, the frozen cellulose nanofiber dispersion liquid was taken out on a petri dish and dried in a vacuum of 10 Pa or less by a freeze dryer (manufactured by Tokyo Rikakikai Co., Ltd.) for 24 hours, thereby obtaining a dried product of cellulose nanofibers. After drying in a vacuum, the cellulose nanofibers were fired at 1200° C. for 2 hours in a nitrogen atmosphere and thus carbonized, thereby producing the cellulose nanofiber carbon of Experimental Example 1.

### Experimental Example 2

The nanocarbon material of Experimental Example 2 is the carbon nanorod produced in the fourth embodiment. In Experimental Example 2, in a crushing step, the cellulose nanofiber carbon produced in Experimental Example 1 was impregnated with water and then crushed with a ball mill (manufactured by Nidec-Shimpo Corporation) for 72 hours. The crushed object was then dried using a hot plate at 80° C. for 12 hours, and thus the water as dispersion medium was evaporated, thereby producing the nanocarbon material of Experimental Example 2.

### Experimental Example 3

The nanocarbon material of Experimental Example 3 is the graphene nanoribbon produced in the fifth embodiment. In Experimental Example 3, the nanocarbon material produced in Experimental Example 2 was stirred in a mixed acid of concentrated nitric acid and concentrated sulfuric acid (concentrated nitric acid:concentrated sulfuric acid=1:2) for 5 hours using a magnetic stirrer. After that, potassium chlorate was added, stirring was continued for 5 hours, and then the liquid mixture was suction-filtered while diluted with water. The exfoliated object collected from the filter paper was placed in a constant temperature bath and dried at 60° C. for 12 hours, followed by reduction treatment at 1100° C. for 5 minutes in an argon atmosphere, thereby producing the nanocarbon material of Experimental Example 3.

### Comparative Example 1

The nanocarbon material of Comparative Example 1 is a nanocarbon material produced by normal drying without undergoing the freezing and drying steps of Experimental Example 1.

In Comparative Example 1, the cellulose nanofiber dispersion liquid prepared in Experimental Example 1 was poured into a petri dish, placed in a constant temperature bath, and dried at 60° C. for 12 hours. Then, the cellulose nanofibers were fired at 1200° C. for 2 hours in a nitrogen atmosphere and thus carbonized, thereby producing a nanocarbon material.

In a crushing step, the cellulose nanofiber carbon was impregnated with water and then crushed with a ball mill (manufactured by Nidec-Shimpo Corporation) for 72 hours. The crushed object was then dried using a hot plate at 80° C. for 12 hours, and thus the water as dispersion medium was evaporated, thereby producing the nanocarbon material of Comparative Example 1.

### Evaluation Method

The nanocarbon materials obtained in Experimental Examples and Comparative Examples were evaluated by XRD measurement, SEM observation, BET specific surface area measurement, and NMR measurement. These nanocarbon materials were confirmed to be single phase carbon (C, PDF card No. 01-071-4630) through XRD measurement. The PDF card No. is a card number of Powder Diffraction File (PDF), which is a database collected by the International Centre for Diffraction Data (ICDD).

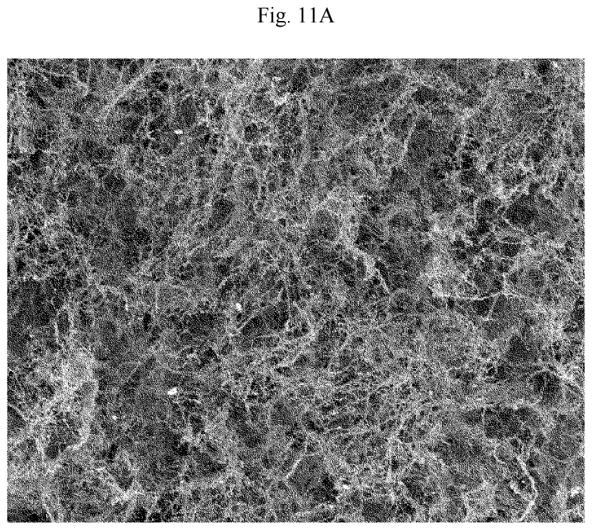

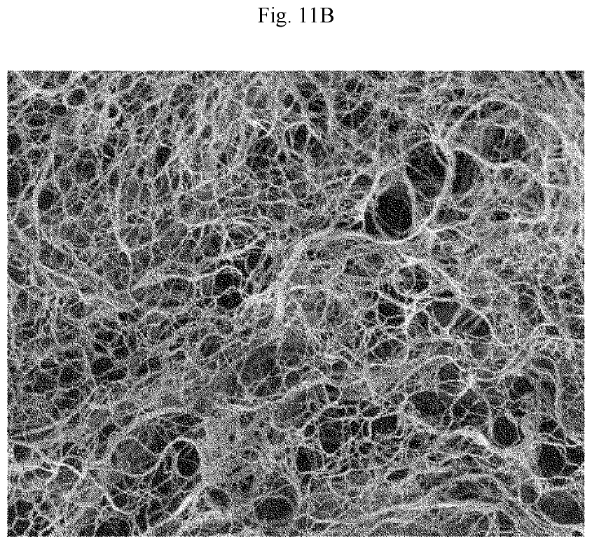

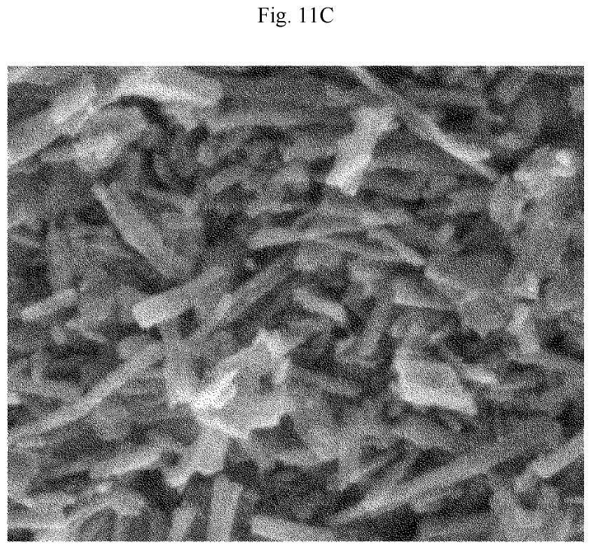

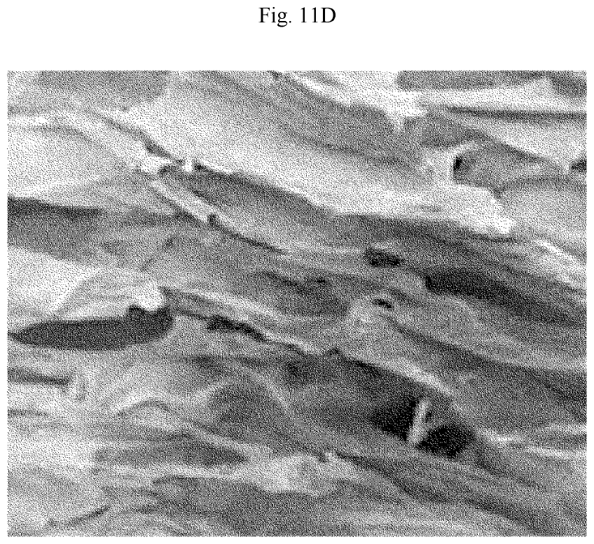

FIGS. 11A, 11B, 11C, and 11D illustrate the SEM images of the produced nanocarbon materials. Table 2 shows the evaluation values obtained by the measurement.

FIGS. 11A, 11B, 11C, and 11D are SEM images of the nanocarbon materials obtained in Experimental Examples 1 and 2, and Comparative Example 1. FIG. 11A is an SEM image of the nanocarbon material obtained in Experimental Example 1 at a magnification of 500 times. FIG. 11B is an SEM image of the nanocarbon material obtained in Experimental Example 1 at a magnification of 10,000 times. FIG. 11C is an SEM image of the nanocarbon material obtained in Experimental Example 2 at a magnification of 100,000 times. FIG. 11D is an SEM image of the nanocarbon material obtained in Comparative Example 1 at a magnification of 10,000 times.

As illustrated in FIGS. 11A and 11B, it can be confirmed that the nanocarbon material of Experimental Example 1 forms a co-continuum in which nanofiber carbon having a fiber diameter of several tens of nm is continuously connected.

As illustrated in FIG. 11C, the nanocarbon material in Experimental Example 2 (fourth embodiment) is confirmed to be carbon nanorods with a rod diameter of several tens of nm and a rod length of about five times the rod diameter.

On the other hand, as illustrated in FIG. 11D, it can be confirmed that the nanocarbon material obtained by performing normal drying on the cellulose nanofiber dispersion liquid of Comparative Example 1 is a densely aggregated nanocarbon material having no rod shape.

As indicated in Table 2, the nanocarbon materials (cellulose nanofiber carbon and carbon nanorods) of Experimental Examples 1 and 2 (fourth embodiment) can suppress the aggregation caused by the surface tension of water due to the evaporation of the dispersion medium as compared with Comparative Example 1 in which normal drying was performed. As a result, it was confirmed that it was possible to provide a nanocarbon material having excellent performance with a high specific surface area and a large total pore volume.

TABLE 2

| Experimental Example/ | | Specific Surface | | Total Pore | Functional Group |
|---|---|---|---|---|---|
| Comparative Example | SEM Observation Result | Area | | Volume | Amount |
| Experimental Example 1 | Co-continuous cellulose | 650 | m²/g | 0.75 cm³/g | 8% |
| | nanofiber carbon with a fiber | | | | |
| | diameter of 20 nmφ | | | | |
| Experimental Example 2 | Carbon nanorods with an average | 850 | m²/g | 0.21 cm³/g | 9% |
| | rod diameter of 30 nm and an | | | | |
| | average rod length of 140 nm | | | | |
| Experimental Example 3 | Graphene nanoribbons with an | 1300 | m²/g | 0.10 cm³/g | 15% |
| | average ribbon width of 20 nm | | | | |
| | and an average ribbon length of | | | | |
| | 80 nm | | | | |
| Comparative Example 1 | Aggregated carbon material | 5 | m²/g | 0.02 cm³/g | 5% |

As indicated in Table 2, it was confirmed that the amounts of functional groups in Experimental Examples 1 and 2 were 9% and 15%, respectively.

As described above, an excellent specific surface area and total pore volume are obtained by the production method of the present embodiment including a freezing step of freezing a dispersion liquid containing cellulose nanofibers to obtain a frozen product, a drying step of drying the frozen product in a vacuum to obtain a dried product, a carbonizing step of heating and carbonizing the dried product in an atmosphere that does not burn the dried product, and a crushing step of crushing the cellulose nanofiber carbon.

The nanocarbon materials produced by the production methods of the fourth and fifth embodiments may be produced by using naturally derived cellulose, the environmental load of which is extremely low. Since these nanocarbon materials are easily disposable in daily life, they can be effectively used in various situations such as small devices, sensor terminals, medical equipment, batteries, beauty appliances, fuel cells, biofuel cells, microbial batteries, capacitors, catalysts, solar cells, semiconductor production processes, filters, heat resistant materials, flame resistant materials, heat insulating materials, conductive materials, electromagnetic wave shield materials, electromagnetic wave noise absorbents, heating elements, microwave heating elements, cone paper, clothes, carpet, mirror anti-fog materials, sensors, and touch panels.

### Sixth Embodiment

In a sixth embodiment and a seventh embodiment described later, a gel containing cellulose nanofibers is used instead of the cellulose nanofiber dispersion liquid of the fourth embodiment. Further, the gels of the sixth and seventh embodiments are bacterial gels in which cellulose nanofibers are dispersed using bacteria. Therefore, the cellulose nanofiber carbon produced by the production methods of the sixth and seventh embodiments will be referred to as “bacterial cellulose carbon” in the following description.

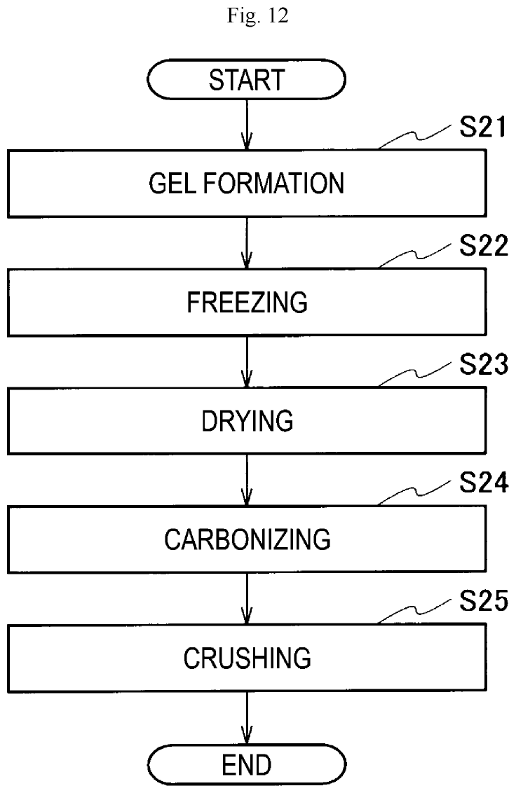

FIG. 12 is a flowchart illustrating a method for producing carbon nanorods (nanocarbon material) derived from bacterial cellulose according to the sixth embodiment.

The method for producing carbon nanorods of the present embodiment includes a gel formation step (step S21), a freezing step (step S22), a drying step (step S23), a carbonizing step (step S24), and a crushing step (step S25).

In the gel formation step, a bacterial gel in which cellulose nanofibers are dispersed using bacteria is formed (step S21). Here, the gel means a gel in which the dispersion medium loses its fluidity due to the three-dimensional network structure of the nanostructure which is a dispersoid and becomes a solid state. Specifically, the gel means a dispersed system with a shear modulus of 102 to 106 Pa. The dispersion medium of the gel includes at least one selected from the group consisting of aqueous media such as water (H2O) and organic media such as carboxylic acids, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The dispersion medium may be composed of at least one selected from the above group.

The gel produced by bacteria has a basic structure of nanofibers on the order of nm, and by producing a nanocarbon material using this gel, the obtained nanocarbon material has a high specific surface area. Specifically, by using the gel produced by bacterial, it is possible to synthesize a nanocarbon material having a specific surface area of 300 m2/g or more.

Bacterial gel has a structure in which nanofibers are entwined in a coil or mesh shape, and further has a structure in which nanofibers are branched based on the growth of bacteria. Therefore, the produced nanocarbon material achieves excellent elasticity with a strain at the elastic limit of 50% or more.

Examples of bacteria include known ones such as those produced by culturing acetobacter such as Acetobacter xylinum subspecies sucrofermentans, Acetobacter xylinum ATCC23768, Acetobacter xylinum ATCC23769, Acetobacter pasturianus ATCC10245, Acetobacter xylinum ATCC14851, Acetobacter xylinum ATCC11142, and Acetobacter xylinum ATCC10821. Further, the bacteria may also be produced by culturing various mutant strains created by mutating these acetic acid bacteria by a known method using NTG (nitrosoguanidine) or the like.

In the freezing step, the bacterial gel is frozen, so that a frozen product is obtained (step S22). In the freezing step, for example, the bacterial gel is put in an appropriate container such as a test tube, and the bacterial gel is frozen in the test tube by cooling the surroundings of the test tube in a coolant such as liquid nitrogen. The freezing method is not particularly limited as long as the dispersion medium of the gel can be cooled to a temperature equal to or lower than the solidifying point, and the dispersion medium may be cooled in a freezer or the like.

By freezing the bacterial gel, the dispersion medium loses its fluidity, the cellulose nanofibers being dispersoids are fixed, and a three-dimensional network structure is constructed.

In the drying step, the frozen product is dried in a vacuum, so that a dried product (bacterial xerogel) is obtained (step S23). In the drying step, the frozen product obtained in the freezing step is dried in a vacuum, and the frozen dispersion medium sublimates from its solid state. For example, the step is performed by storing the obtained frozen product in an appropriate container such as a flask and vacuuming the inside of the container. By placing the frozen product in a vacuum atmosphere, the sublimation point of the dispersion medium decreases, so that even a substance that does not sublimate under normal pressure can sublimate.

The degree of vacuum in the drying step is different depending on the dispersion medium to be used but is not particularly limited as long as the dispersion medium sublimates at such a degree of vacuum. For example, when water is used as the dispersion medium, the degree of vacuum needs to be 0.06 MPa or less, but it takes time to dry because heat is taken away as latent heat of sublimation. Therefore, the degree of vacuum is preferably from 1.0×10-6 Pa to 1.0×10-2 Pa. In addition, heat may be applied using a heater or similar device during drying.

In the carbonizing step, the dried product (bacterial xerogel) is heated and carbonized in an atmosphere that does not burn the dried product, so that bacterial cellulose carbon is obtained (step S24). It is only required that the bacterial xerogel be carbonized, being fired in an inert gas atmosphere at 500° C. to 2000° C., more preferably 900° C. to 1800° C. The gas that does not burn cellulose is only required to be, for example, an inert gas such as nitrogen gas or argon gas. Further, the gas that does not burn cellulose may be a reducing gas such as hydrogen gas or carbon monoxide gas, or may be carbon dioxide gas. In the present embodiment, carbon dioxide gas or carbon monoxide gas is more preferable because they have activation effect on nanocarbon materials and thus are expected to highly activate nanocarbon materials.

In the crushing step, the dried product (bacterial cellulose carbon) carbonized in the above carbonizing step (step S24) is crushed (step S25). In the crushing step, bacterial cellulose carbon is crushed into powder or slurry using, for example, a mixer, a homogenizer, an ultrasonic homogenizer, a high-speed rotary shear type stirrer, a colloid mill, a roll mill, a high-pressure injection disperser, a rotary ball mill, a vibrating ball mill, a planetary ball mill, or an attritor. The crushing method includes a wet crushing method and a dry crushing method, and a wet crushing method capable of more uniform and fine crushing is preferable.

The solvent used in the wet crushing method is not particularly limited, and includes at least one selected from, for example, the group consisting of aqueous solvents such as water (H2O) and organic solvents such as carboxylic acid, methanol (CH3OH), ethanol (C2H5OH), propanol (C3H7OH), n-butanol, isobutanol, n-butylamine, dodecane, unsaturated fatty acids, ethylene glycol, heptane, hexadecane, isoamyl alcohol, octanol, isopropanol, acetone, and glycerin. The solvent may be composed of at least one selected from the above group.

The carbon nanorods derived from bacterial cellulose preferably have a rod length of 10 nm to 400 nm, and more preferably 50 nm to 200 nm. The reason for this is that when the carbon nanorods are crushed until the rod length becomes 10 nm or less, the aspect ratio (rod length/rod width) of the carbon nanorods becomes small, and the specificity due to the shape of the carbon nanorods is lost. Further, when the length of the carbon nanorods is 400 nm or more, the branched structure of the bacterial cellulose carbon remains, which makes it difficult to produce carbon nanorods.

According to the method for producing carbon nanorods derived from bacterial cellulose described above, in the freezing step, the cellulose nanofibers being dispersoids are fixed and cellulose nanofibers with a three-dimensional network structure maintained are constructed. In addition, because of the drying step, cellulose nanofibers can be taken out while the three-dimensional network structure is maintained. By carbonizing while maintaining this three-dimensional network structure and crushing the branched structure, it becomes easy to produce carbon nanorods having a high specific surface area. Therefore, the present embodiment provides a method for easily mass-producing carbon nanorods at low cost.

As described above, the carbon nanorods produced by the production method of the present embodiment have high conductivity, corrosion resistance, and high specific surface area.

Therefore, the carbon nanorods produced by the production method of the present embodiment are suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbing materials, heating elements, microwave heating elements, cone paper, clothes, carpets, mirror fogging prevention materials, sensors, and touch panels.

### Seventh Embodiment

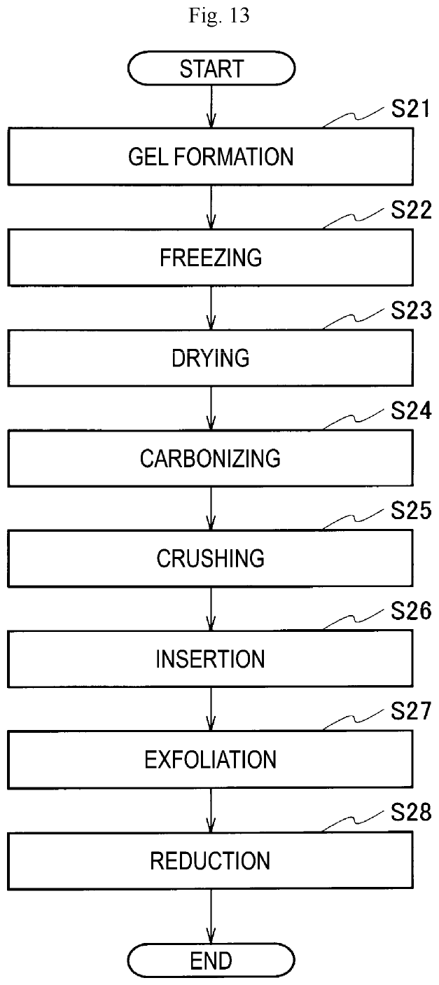

FIG. 13 is a flowchart illustrating a method for producing graphene nanoribbons derived from bacterial cellulose according to the seventh embodiment. The production method illustrated in FIG. 13 further includes an insertion step (step S26), an exfoliation step (step S27), and a reduction step (step S28) in the production method of the seventh embodiment. That is, in the method for producing graphene nanoribbons of the present embodiment, the carbon nanorods obtained in the sixth embodiment are subjected to an insertion step, an exfoliation step, and a reduction step described later, so that graphene nanoribbons (nanocarbon material) are obtained. Since the steps S21 to 25 are the same as those in the sixth embodiment, description thereof will be omitted here.

In the insertion step, the intercalators are inserted between the graphite layers of the bacterial cellulose nanofiber carbon (carbon nanorods) crushed in the above crushing step (step S25), so that an interlayer compound is obtained (step S26). The interlayer compound is a carbon nanorod in which the intercalators are inserted. Here, the “intercalator” refers to an interstitial substance such as an atom, ion, or molecule that is inserted between graphene and graphene (between graphite layers) constituting carbon.

The intercalator is not limited as long as it can be inserted between graphite layers. The intercalator includes, for example, at least one selected from the group consisting of: single metal atoms such as K, Rb, Cs, Li, Ca, Sr, Ba, Sm, Eu, and Yb; halogen molecules such as Br₂, I₂, Cl₂, and ICI; fluorides containing Kr, B, P, Cl, Br, Si, Ti, Xe, P, As, Sb, Nb, Ta, I, Mo, W, or U; chlorides containing Mg, Zn, Cd, Hg, Mn, Fe, Co, Ni, Pd, Cu, B, Al, Ga, In, Tl, Cr, Fe, Ru, Os, Au, Y, Sm, Eu, Gd, Tb, Dy, Ho, Er, Tm, Yb, Lu, Zr, Hf, Sb, Bi, Nb, Ta, Mo, U, Te, or W; bromides containing Cd, Hg, Fe, Al, Ga, Tl, Fe, Au, or U; oxides such as N₂O₅, SO₃, SeO₃, CrO₃, MoO₃, Cl₂O₇, Re₂O₇, and P₄O₁₀; and acids such as HNO₃, H₂SO₄, HClO₄, H₃PO₄, HF, and CF₃COOH. The intercalator may be composed of at least one selected from the above group.

The insertion step is not particularly limited as long as the above intercalators are inserted between the graphite layers, and examples thereof include a method in which an intercalator in a gas phase is reacted with carbon (gas phase method), a method in which an intercalator in a liquid phase is reacted with carbon (liquid phase method), and a method in which an intercalator in a solid phase is reacted with carbon (solid phase method). The liquid phase method is preferable because it can be carried out at room temperature, the reaction rate is high, and it allows mass production.

Specifically, in the liquid phase method, it is only required that a solution containing intercalators and carbon nanorods derived from bacterial cellulose be mixed. For mixing, it is only required that, for example, a homogenizer, an ultrasonic cleaner, an ultrasonic homogenizer, a magnetic stirrer, a stirrer, or a shaker be used.

In the exfoliation step, the interlayer compound produced in the above insertion step (step 26) is exfoliated into individual layers (step S27).

The exfoliation step is not particularly limited as long as the interlayer compound can be exfoliated into individual layers, and the exfoliation can be progressed by performing, for example, ultrasonic irradiation, microwave irradiation, oxidation treatment, or heat treatment.

The production process illustrated in FIG. 12 includes a reduction step (step 28), but the reduction step (step 28) may be omitted. That is, when the exfoliated product obtained in the above exfoliation step is graphene nanoribbons derived from bacterial cellulose, the reduction step is unnecessary.

In the exfoliation step, when the interlayer compound is exfoliated into individual layers, the oxidation reaction proceeds and the exfoliated material may be graphene oxide nanoribbon. In that case, the graphene oxide nanoribbons can be reduced to graphene nanoribbons by performing chemical reduction, electro-reduction, thermal reduction, or photo-irradiation in the reduction step (step 28).

The present embodiment provides a method for easily mass-producing graphene nanoribbons at low cost by using the carbon nanorods obtained by the production method of the sixth embodiment.

For the purpose of confirming the effects of the production methods of the sixth and seventh embodiments described above, an experiment was carried out in which the nanocarbon materials produced by the production methods of the sixth and seventh embodiments (Experimental Examples 3 and 4) were compared with the nanocarbon material produced by a production method different from that of the above embodiments (Comparative Example 2).

### Experimental Example 3

Using Nata de coco (manufactured by Fujicco Co., Ltd.) as a bacterial cellulose gel produced by Acetobacter xylinum, which is an acetic acid bacterium, the bacterial gel was completely frozen, being immersed in liquid nitrogen for 30 minutes in a Styrofoam box. After the bacterial gel was completely frozen, the frozen bacterial gel was taken out on a petri dish and dried in a vacuum of 10 Pa or less by a freeze dryer (manufactured by Tokyo Rikakikai Co., Ltd.), so that bacterial xerogel was obtained. After the bacterial xerogel was dried in a vacuum, the bacterial xerogel was fired at 1200° C. for 2 hours under a nitrogen atmosphere and thus carbonized, thereby producing bacterial cellulose carbon.

In a crushing step, the bacterial cellulose carbon was impregnated with water and then crushed with a ball mill (manufactured by Nidec-Shimpo Corporation) for 72 hours. The crushed object was then dried using a hot plate at 80° C. for 12 hours and thus the water as dispersion medium was evaporated, thereby producing the nanocarbon material (carbon nanorods) of Experimental Example 3.

### Experimental Example 4

The nanocarbon material prepared in Experimental Example 3 was stirred in a mixed acid of concentrated nitric acid and concentrated sulfuric acid (concentrated nitric acid:concentrated sulfuric acid=1:2) for 5 hours using a magnetic stirrer. After that, potassium chlorate was added, stirring was continued for 5 hours, and then the liquid mixture was suction-filtered while diluted with water. The exfoliated object collected from the filter paper was placed in a constant temperature bath and dried at 60° C. for 12 hours, followed by reduction treatment at 1100° C. for 5 minutes in an argon atmosphere, thereby producing the carbon material (graphene nanoribbons) of Experimental Example 4.

### Comparative Example 2

The nanocarbon material of Comparative Example 2 is a nanocarbon material produced by normal drying without undergoing the freezing and drying steps described above.

In Comparative Example 2, the bacterial gel used in Experimental Example 3 was placed in a constant temperature bath and dried at 60° C. for 12 hours. Then, the bacterial cellulose was fired at 1200° C. for 2 hours in a nitrogen atmosphere and thus carbonized, thereby producing nanocarbon materials.

In a crushing step, the bacterial cellulose carbon was impregnated with water and then crushed with a ball mill (manufactured by Nidec-Shimpo Corporation) for 72 hours. The crushed object was then dried using a hot plate at 80° C. for 12 hours, and thus the water as dispersion medium was evaporated, thereby producing the nanocarbon material of Comparative Example 2.

### Evaluation Method

The obtained nanocarbon material was evaluated by XRD measurement, SEM observation, BET specific surface area measurement, and NMR measurement, as in Experimental Examples 1 and 2 and Comparative Example 1. This nanocarbon material was confirmed to be single phase carbon (C, PDF card No. 01-071-4630) through XRD measurement. Table 3 shows the evaluation values obtained by the measurement.

The SEM image of the nanocarbon material obtained in Experimental Example 3 was similar to that in FIG. 11A (Experimental Example 1), and it was confirmed that the nanocarbon material obtained by the production method of the sixth embodiment is a carbon nanorod with a rod diameter of several tens of nm and a rod length of about five times the rod diameter.

On the other hand, the SEM image of the nanocarbon material obtained in Comparative Example 2 was similar to that of FIG. 11B (Comparative Example 1), and it was confirmed that the nanocarbon material obtained by performing normal drying on the bacterial gel containing water was a densely aggregated nanocarbon material having no rod shape.

As indicated in Table 3, the nanocarbon material of the sixth embodiment (Experimental Example 3) can suppress the aggregation caused by the surface tension of water due to the evaporation of the dispersion medium as compared with Comparative Example 2 in which normal drying was performed. As a result, it was confirmed that it was possible to provide a nanocarbon material having excellent performance with a high specific surface area and a large total pore volume.

TABLE 3

| Experimental Example/ | | Specific Surface | | Total Pore | Functional Group |
|---|---|---|---|---|---|
| Comparative Example | SEM Observation Result | Area | | Volume | Amount |
| Experimental Example 3 | Carbon nanorods with an average | 930 | m²/g | 0.30 cm³/g | 6% |
| | rod diameter of 20 nm and an | | | | |
| | average rod length of 100 nm | | | | |
| Experimental Example 4 | Graphene nanoribbons with an | 1400 | m²/g | 0.10 cm³/g | 13% |
| | average ribbon width of 15 nm and | | | | |
| | an average ribbon length of 40 nm | | | | |
| Comparative Example 2 | Aggregated carbon material | 7 | m²/g | 0.04 cm³/g | 4% |

As indicated in Table 3, it was confirmed that the amounts of functional groups in Experimental Examples 3 and 4 were 6% and 13%, respectively.

As described above, an excellent specific surface area and total pore volume are obtained by the production method of the present embodiment including a freezing step of freezing bacterial gel to obtain a frozen product, a drying step of drying the frozen product in a vacuum to obtain a dried product, a carbonizing step of heating and carbonizing the dried product in an atmosphere that does not burn the dried product, and a crushing step of crushing the bacterial cellulose carbon.

The nanocarbon materials produced by the production methods of the sixth and seventh embodiments may be produced by using naturally derived cellulose, the environmental load of which is extremely low. Since these nanocarbon materials are easily disposable in daily life, they can be effectively used in various situations such as small devices, sensor terminals, medical equipment, batteries, beauty appliances, fuel cells, biofuel cells, microbial batteries, capacitors, catalysts, solar cells, semiconductor production processes, filters, heat resistant materials, flame resistant materials, heat insulating materials, conductive materials, electromagnetic wave shield materials, electromagnetic wave noise absorbents, heating elements, microwave heating elements, cone paper, clothes, carpet, mirror anti-fog materials, sensors, and touch panels.

The present invention is not limited to the above embodiment and can be modified within the scope of the gist thereof.

### REFERENCE SIGNS LIST

S1 Dispersing step
S2 Spray freezing step
S3, S13, S23: Drying step
S4, S14, S24: Carbonizing step
S5, S15, S25: Crushing step
S6, S17, S27: Exfoliation step
S7, S18, S28: Reduction step
S16, S26: Insertion step
S21 Gel formation step

1. A method for producing a spherical nanocarbon fiber assembly, the method comprising:
freezing a dispersion liquid containing cellulose nanofibers by spraying the dispersion liquid on a brine solution to obtain a frozen product;
drying the frozen product in a vacuum to obtain a dried product; and
heating the dried product in an atmosphere that does not burn the dried product, thereby carbonizing the dried product to obtain a spherical nanocarbon fiber assembly.

2. The method for producing the spherical nanocarbon fiber assembly according to claim 1, wherein
in the freezing, particles of atomized cellulose nanofibers having a particle size adjusted by at least one of a spray nozzle, a flow rate, or a spray pressure are sprayed.

3. A method for producing a carbon nanorod, the method comprising:
crushing the spherical nanocarbon fiber assembly obtained by the method for producing the spherical nanocarbon fiber assembly according to claim 1 to obtain a carbon nanorod.

4. A method for producing a carbon nanorod, the method comprising:
freezing a dispersion liquid or gel containing cellulose nanofibers to obtain a frozen product;
drying the frozen product in a vacuum to obtain a dried product;
heating the dried product in an atmosphere that does not burn the dried product, thereby carbonizing the dried product to obtain cellulose nanofiber carbon; and
crushing the cellulose nanofiber carbon to obtain a carbon nanorod.

5. A method for producing a graphene nanoribbon, the method comprising:
inserting intercalators between graphite layers of the carbon nanorod obtained by the method for producing the carbon nanorod according to claim 3 to obtain an interlayer compound; and
exfoliating each of the graphite layers of the interlayer compound to obtain a graphene nanoribbon.

6. A method for producing a carbon nanorod, the method comprising:
crushing the spherical nanocarbon fiber assembly obtained by the method for producing the spherical nanocarbon fiber assembly according to claim 2 to obtain a carbon nanorod.

7. A method for producing a graphene nanoribbon, the method comprising:
inserting intercalators between graphite layers of the carbon nanorod obtained by the method for producing the carbon nanorod according to claim 4 to obtain an interlayer compound; and
exfoliating each of the graphite layers of the interlayer compound to obtain a graphene nanoribbon.
